(19) United States
(12) Patent Application Publication
(10) Pub. No.: US 2013/0077914 A1
(43) Pub. Date: Mar. 28, 2013

(54) Optical LC Normal Through Adapter

(71) Applicants: Richard Colin Edward Durrant, Crystal Lake, IL (US); Darren James Michael Adams, Haverhill (GB); Justin Daniel Noble, Steeple Morden (GB)

(72) Inventors: Richard Colin Edward Durrant, Crystal Lake, IL (US); Darren James Michael Adams, Haverhill (GB); Justin Daniel Noble, Steeple Morden (GB)

(73) Assignee: Advanced Fiber Products Limited, Haverhill (GB)

(21) Appl. No.: 13/245,845

(22) Filed: Sep. 26, 2011

(51) Int. Cl. G02B 6/26

(52) U.S. Cl. 385/16

(57) ABSTRACT

An optical switching apparatus comprising a housing with first and second optical ports on the housing for receiving optical connectors, wherein the first and second optical ports are optically connected in a first state. A third and fourth optical port for receiving optical connectors are provided in the housing for which are optically connected in a first state. An optical switch within the housing optically connects the first optical port to the third optical port and optically connects that the second optical port to the fourth optical port in a second state, wherein the optical switch is mechanically actuated due to insertion of an optical connector in at least one of the first and second optical ports. A sliding cam against a ball bearing accurately re-aligns two fiber optic arrays to switch from a first state to a second state.

### BACKGROUND OF THE INVENTION

1. Field of the Invention

The present invention relates generally to patch panels, and more particularly, to optical switching technology.

2. Description of Related Art

Conventional designs for normal through patch panels typically require external power to operate the switching functions, proprietary connector interfaces or are designed for a limited number of connector configurations and transmission channels. Additionally, conventional patch panel designs or normal through patch panel designs are large and heavy mechanisms.

Accordingly, there is a need for a normal through mechanical optical patch panel that is compact, lightweight, passive, uses industry standard connector interfaces and is capable of accommodating multiple optical connector configurations and high density optical channel management.

### SUMMARY OF THE INVENTION

In accordance with the present invention, a passive optical switch is provided that is mechanically actuated by the insertion of industry standard optical duplex or multi-fiber connector into its ports. The reduction in use of patch cables greatly reduces the volume and weight of cabling required in an installation important in mobile network applications.

Optical normal through technology enables a network designer or user, typically in a broadcast or military networking applications to significantly reduce the complexity and number of the optical patch cable requirements and associated patching hardware by allowing “normal” patch routings to be set up without the typical use of patch cables on the front of the panel. All of the standard routings can be pre-configured with minimal space use on the rear of a high density patch-panel. Very similar in functionality to existing equivalent copper RF and RJ-45 type “normal-through” adaptors, the optical normal through also allows, when needed, for conventional patch cables to be plugged into the patch panel, to enable the automatic routing in and out of signals for temporary fiber channel routing or networks changes.

The present invention further provides connection ports to the device which are for industry standard low insertion loss duplex connectors like LC, and is capable of providing normal though duplex channel functionality for both single mode and multimode fiber channels. The optical patch panel is mechanically operated without the necessity of external power and provides for normal through optical connectivity without the use of excessive patch cables. The space envelop required by the present invention is very small and similar to conventional copper counterparts. The switching functionally provided by the present invention is low loss in both the normal through or switched out modes.

Accordingly, an optical switching apparatus is provided comprising a housing with first and second optical ports on the housing for receiving optical connectors, wherein the first and second optical ports are optically connected in a first state. A third and fourth optical port for receiving optical connectors are provided in the housing which are optically connected in a first state. An optical switch within the housing optically connects the first optical port to the third optical port, and optically connects that the second optical port to the fourth optical port in a second state, wherein the optical switch is mechanically actuated responsive to insertion of an optical connector in at least one of the first and second optical ports. A sliding cam against a ball bearing accurately re-aligns two fiber optic arrays to switch from a first state to a second state.

The foregoing has outlined, rather broadly, the preferred features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiments as a basis for designing or modifying other structures for carrying out the same purposes of the present invention and that such other structures do not depart from the spirit and scope of the invention in its broadest form.

### BRIEF DESCRIPTION OF THE DRAWINGS

FIG. 1a is a top view of an optical normal through configured in accordance with the present invention;

FIG. 1b a side view of the optical normal shown in FIG. 1a;

FIG. 1c is a bottom view of the optical normal through shown in FIGS. 1a and 1b;

FIG. 1d is an end view of the optical normal through shown FIGS. 1a, 1b and 1c;

FIG. 2 is a top view of the optical normal through shown in FIG. 1a with the top cover removed showing the internal components;

FIG. 2a is an enlarged view of an optical switcher located within the optical normal through shown in FIGS. 1a-1d and FIG. 2;

FIG. 3a is a bottom view of an optical normal through configured in accordance with the present invention;

FIG. 3b is an end view of multiple optical normal through as shown in FIG. 3a mounted immediately adjacent to each other to form an optical patch panel;

FIG. 3c is a side view of the stack of multiple optical normal throughs shown in FIG. 3b;

FIG. 4a is a schematic diagram of an optical normal through configured in accordance with the present invention in the unswitched or first state position;

FIG. 4b is a schematic diagram of the optical normal through shown in FIG. 2b in the switched or second state position;

FIG. 5a is a schematic diagram of a double phase translation optical normal through configured in accordance with the present invention in a non-switched or first state position;

FIG. 5b is a schematic diagram of the optical normal through shown in FIG. 5a in a switched or second state position;

FIG. 5c is a schematic diagram of a single phase translation optical normal through configured in accordance with the present invention in a non-switched or first state position;

FIG. 5d is a schematic diagram of the optical normal through shown in FIG. 5c is a switched or second state position;

FIG. 5e is a schematic diagram of an alternative single phase translation optical normal through configured in accordance with the present invention in a non-switched or first state position;

FIG. 5f is a schematic diagram of the optical normal through shown in FIG. 5e is a switched or second state position;

FIG. 6 illustrates two fiber optic arrays of an optical switch configured in accordance with the present invention in the second state or switched position and illustrates the use of an industry standard array ferrule like an MT array ferrule for the switching mechanism, and the phased translation of the fiber arrays relative to one another; and

FIG. 7 illustrates a process of the present invention for manufacturing one embodiment of the two fiber optic arrays of the optical switch using V-array fiber mounting plates of silica or Pyrex® or other precisely machined material combinations for the fiber array switching interfaces shown in FIG. 6.

### DETAILED DESCRIPTION OF THE PREFERRED EMBODIMENT

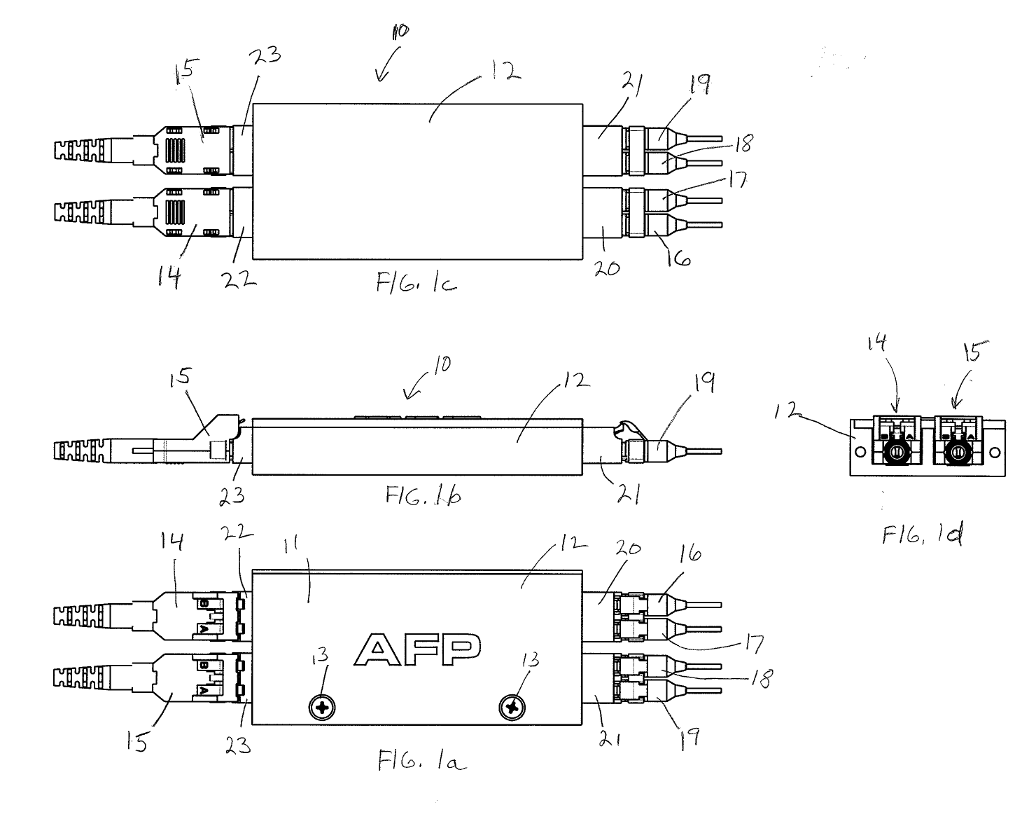

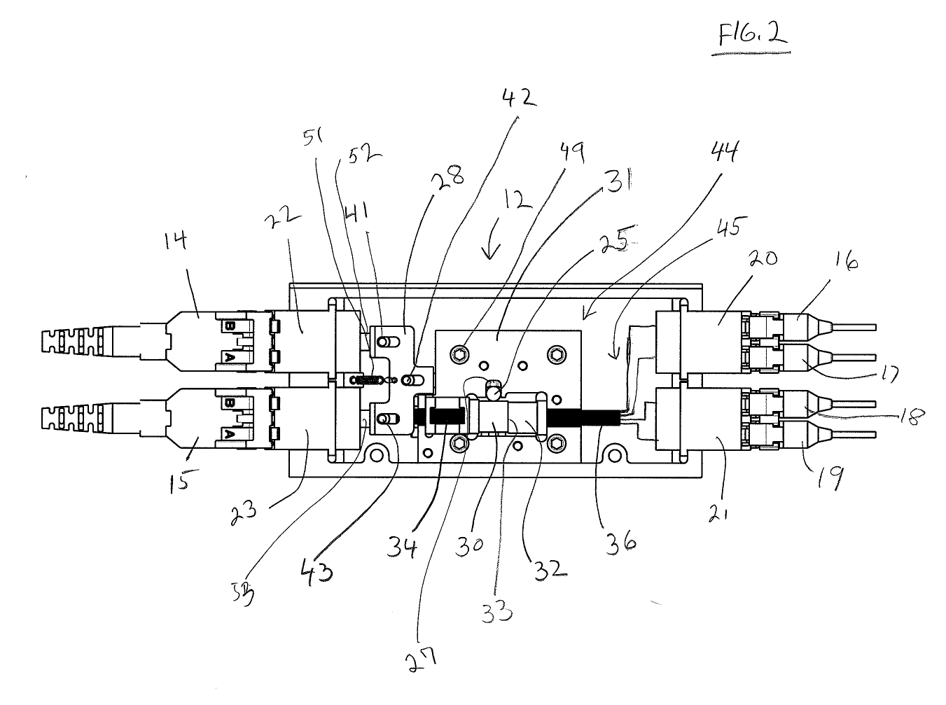

Referring now to the drawings, FIG. 1 illustrates a top view of an optical normal through 10 configured in accordance with the present invention. The housing 12 can be constructed of plastic or metal. A top plate 11 is preferably secured to the housing by screws 13.

Ports 22,23 on the housing 12 are configured to receive optical connectors 14,15 having an industry standard LC configuration. Ports 21,22 on the housing 12 are configured to receive optical connectors 16, 17, 18, 19 having an industry standard LC configuration. Of course, other optical connector configurations can be used on the optical normal through 10 including connectors with more fibers than a duplex configuration.

FIG. 1b is side view of the optical normal though 10 shown in FIG. 1a. FIG. 1b shows the housing 12, optical ports 21,23, and optical connectors 15,19.

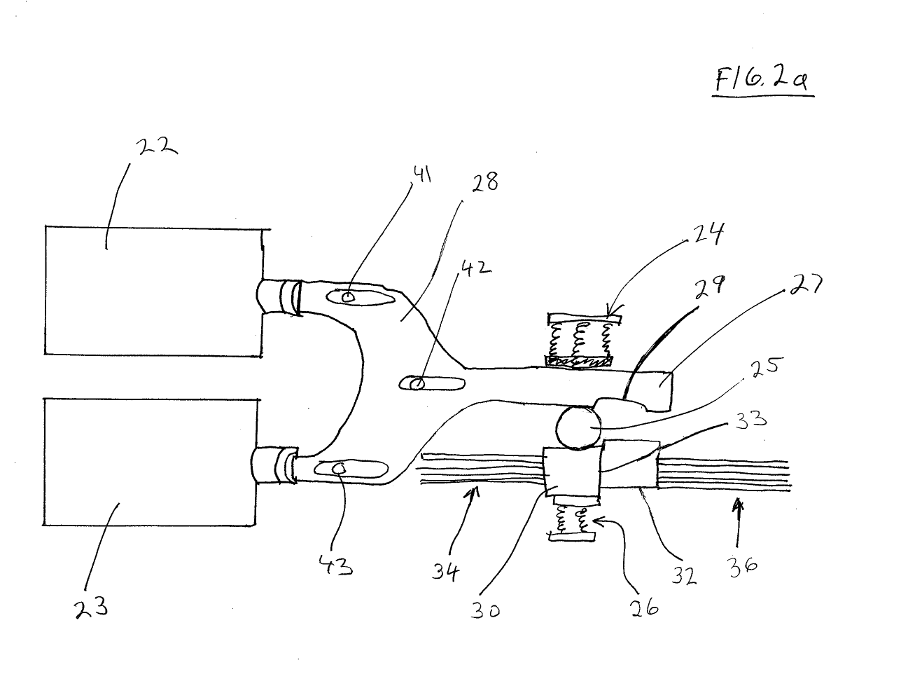

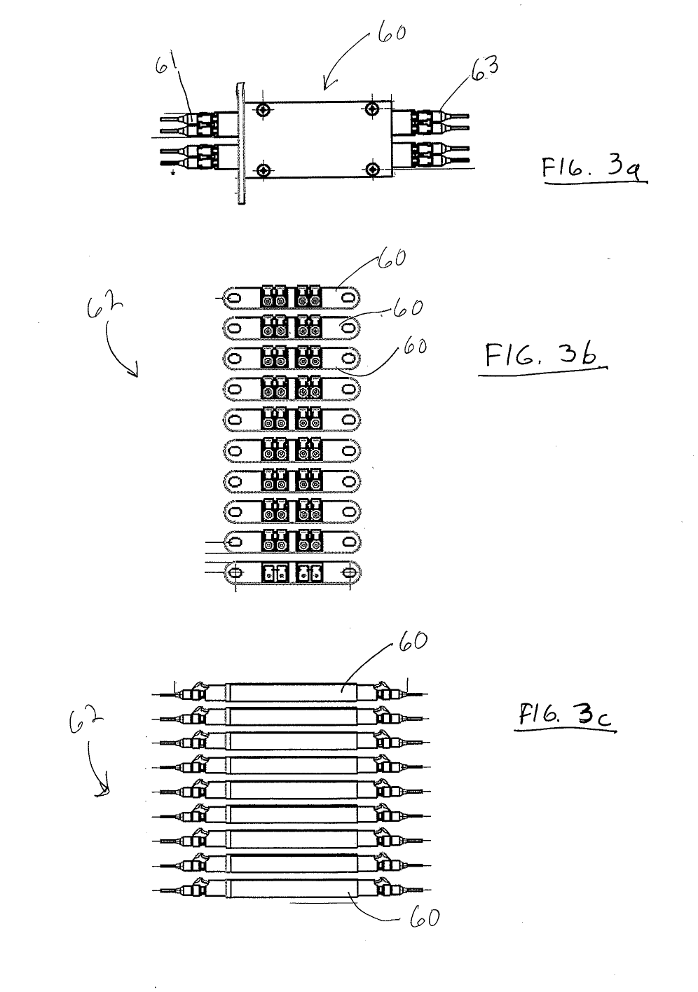

FIG. 1c is a bottom view of the housing 12 shown in FIGS. 1a and 1b. FIG. 2c shows the housing 12, ports 20, 21, 22, 23 and optical connectors 14, 15, 16, 17, 18, 19.

FIG. 1d is an end view of the optical normal through 10 shown in FIGS. 1a, 1b, 1c. FIG. 1d shows the LC optical connectors 14,15.

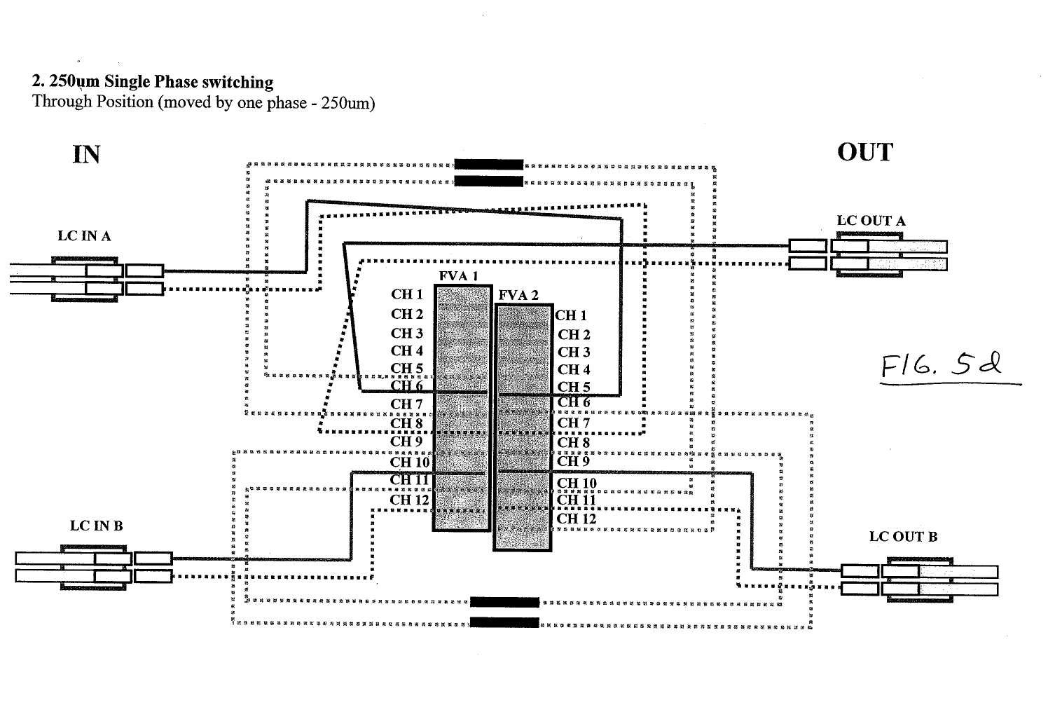

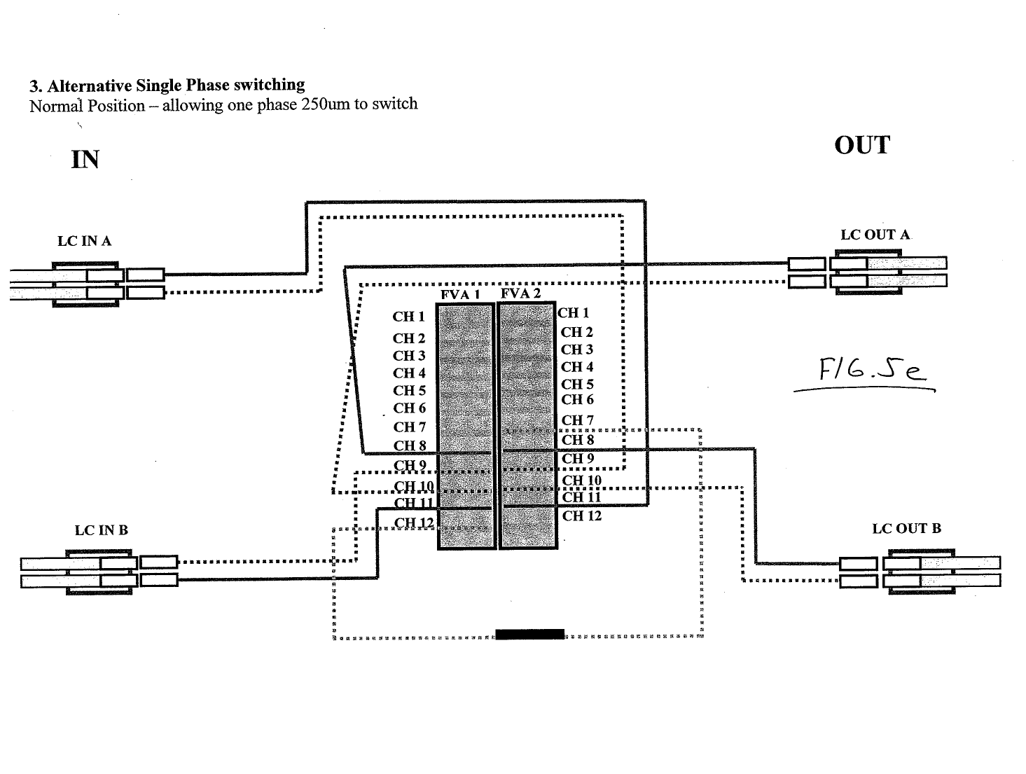

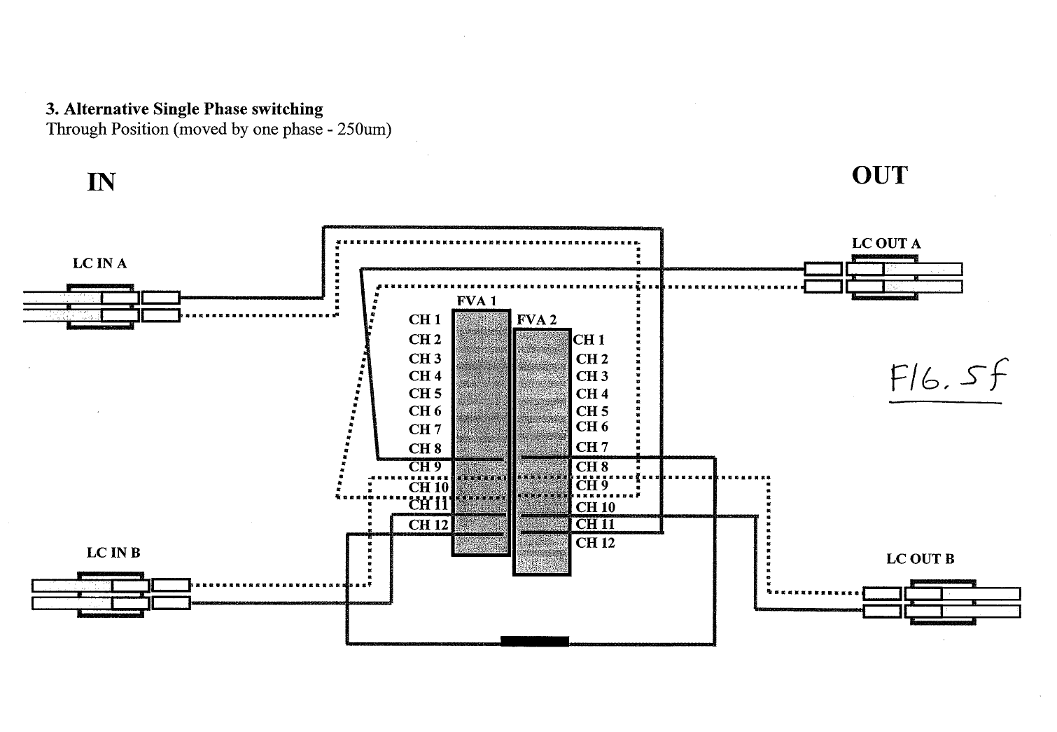

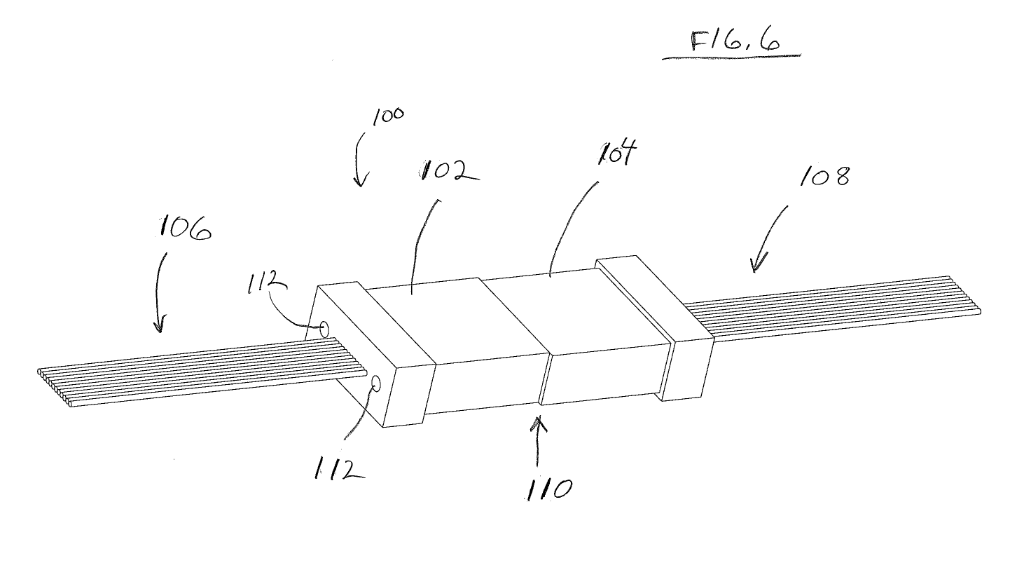

FIG. 2 is illustrates the optical normal through shown in FIGS. 1a-1d with the top cover 11 removed so an optical switch 44 and related components contained therein can be illustrated. The optical switch 44 is shown providing an optical connection between the optical ports 20, 21, 22, 23. Optical fibers 45 from optical ports 20,21 are shown as extensions of fiber ribbon cable 36 which enters the optical switch 44. Similarly, fiber ribbon cable 34 optically connects optical ports 23,23 to the optical switch 44. A plate 31, secured by screws 49, covers optical fibers that assist in rerouting of optical connections provided by the optical switch 44. These optical fiber connections are shown schematically in FIGS. 5a-5f.

In accordance with the present invention, two fiber arrays in opposing MT ferrules or opposing fiber V arrays 30,32 of optical fibers positioned within the same geometric plane and in direct slidable contact, move laterally to switch optical channels between the two fiber arrays 30,32. A slidable cam 27 including a notch 29 (FIG. 2a) slides against a ball bearing 25 or bearing wall to accurately slide a first fiber MT ferrule or V-groove array (FVA) 30 laterally against a second MT ferrule or fiber V-groove array (FVA) 32 at a juncture 33 wherein the first and second MT ferrules or FVAs are in direct slidable contact. In accordance with a further aspect of the present invention, an index matching gel is applied to the MT ferrule arrays or FVAs at the juncture 33 to further improve optical communication at the juncture 33 and lubrication of the slidable surfaces.

A Y-bar 28 is slidably connected to the optical ports 22,23 so as to be actuated and slide toward the juncture 33 when an optical connector is inserted into either port 22 or 23. A spring 51 provides small resistance on the Y-bar away from the juncture 33, until the Y-bar is move toward the juncture 33 in response to an optical connector being inserted or connected to optical port 22 or 23. Pins 41, 42, 43 are located in elongated apertures within the Y-bar to guide the Y-bar while transitioning between different switching positions.

FIG. 2a illustrates the Y-bar 28 with the cover plate 31 removed. Also shown is the Y-bar bar connected to the slidable cam 27. The cam has a notch 29 on the side of the cam 27 that rides against the ball bearing 25. The Illustrated cam 27 is a flat bar with a notch 29, but could be a round bar with a notch or other configurations. Similarly, the ball bearing 25 could be any bearing surface in other embodiments. Spring bars 24 and 26 provide a force to keep the cam 27 and ball bearing 25 adjacent to each other as the cam 27 slides back and forth between switching positions. As illustrated in FIG. 2a, the movement of the cam 27 to the right causes the ball bearing 25 to move the first fiber array 30 away from the cam 27 to move into the second state or switched position in response to an optical connector being inputted into optical port 22 or 23. Of course, the notch 29 in the cam 27 could be repositioned so the notch 29 is located further left on the cam 27, and inputting an optical connector causes the ball bearing 25 to move into the notch 29, and move the first MT ferrule or FVA 30 towards, instead of away from, the cam 27.

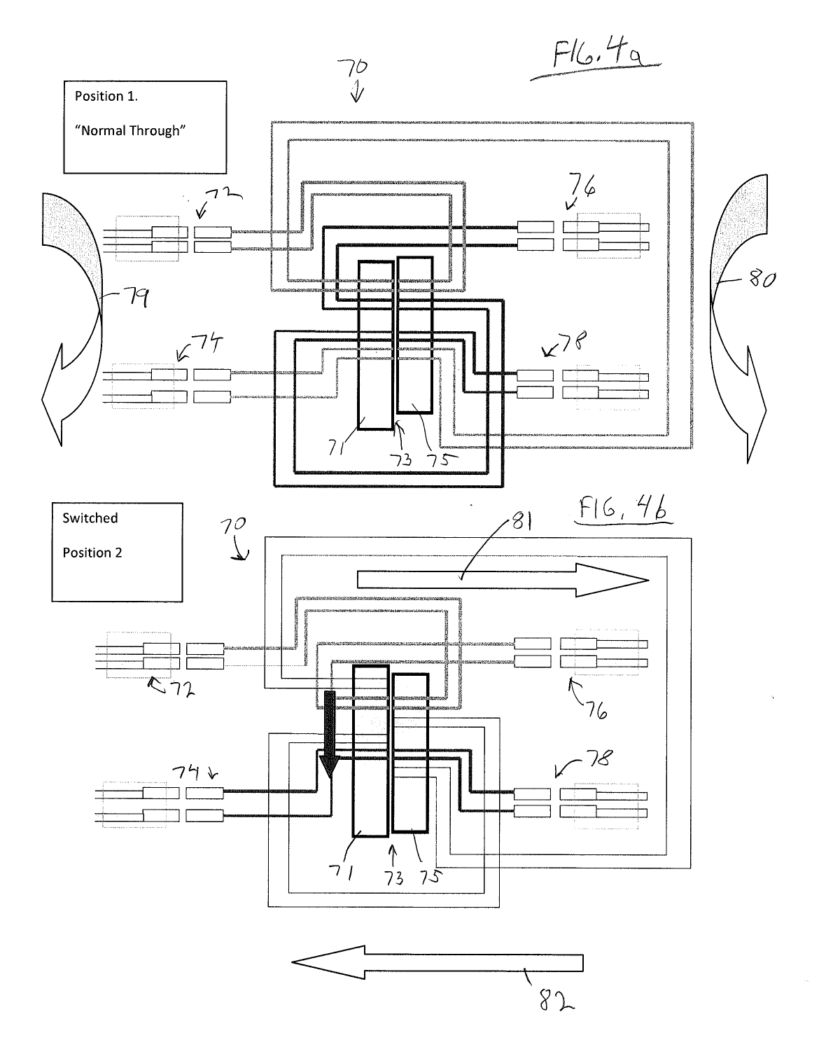

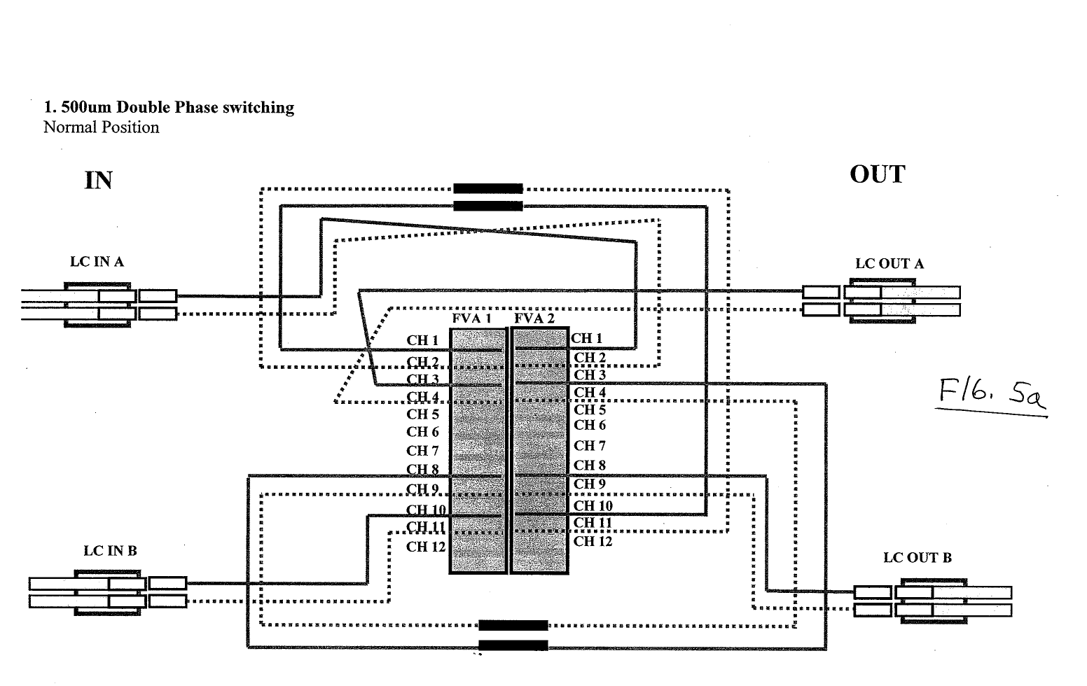

FIG. 3a illustrates a top view of an optical normal through 60 configured in accordance with the present invention. LC optical connectors 61 are shown connected to the front panel of the optical normal through 60, and LC optical connectors 63 are shown connected to the rear of the optical normal through.

Of course, ports of the optical normal through can be configured to connect with numerous types of optical connectors. For example, all optical ports could be duplex LC, duplex SC, MT-RJ or any other duplex connector. All the optical ports could be MTs greater than 2 fiber duplex, such as 8-way connectors, but then the optical switch would need to have more than 8 opposing fibers in each MT ferrule or FVA to switch two duplex connectors.

FIG. 3b illustrates a plurality of the optical normal throughs 60 stacked adjacent to each other to form a “patch panel.” FIG. 3b is a front view of the LC connectors 61 on the “front” of the “patch panel” created by stacking multiple optical normal throughs 60 adjacent to each other.

FIG. 3c is a side view of the stacked optical normal throughs 60 shown in FIG. 3b.

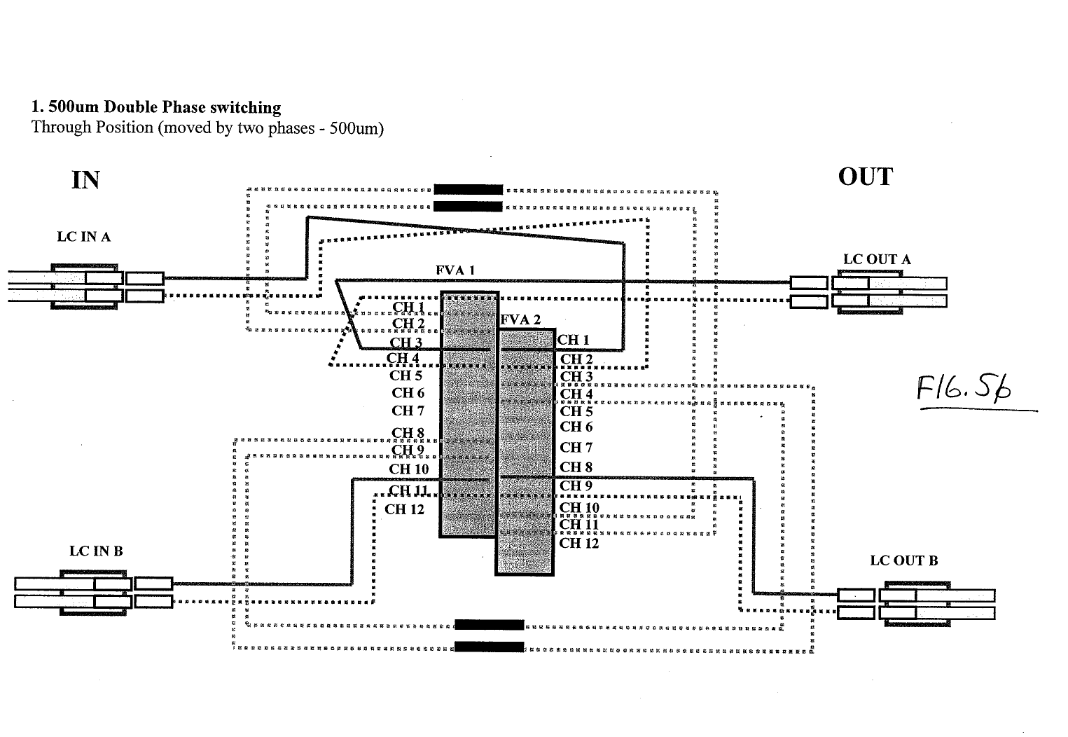

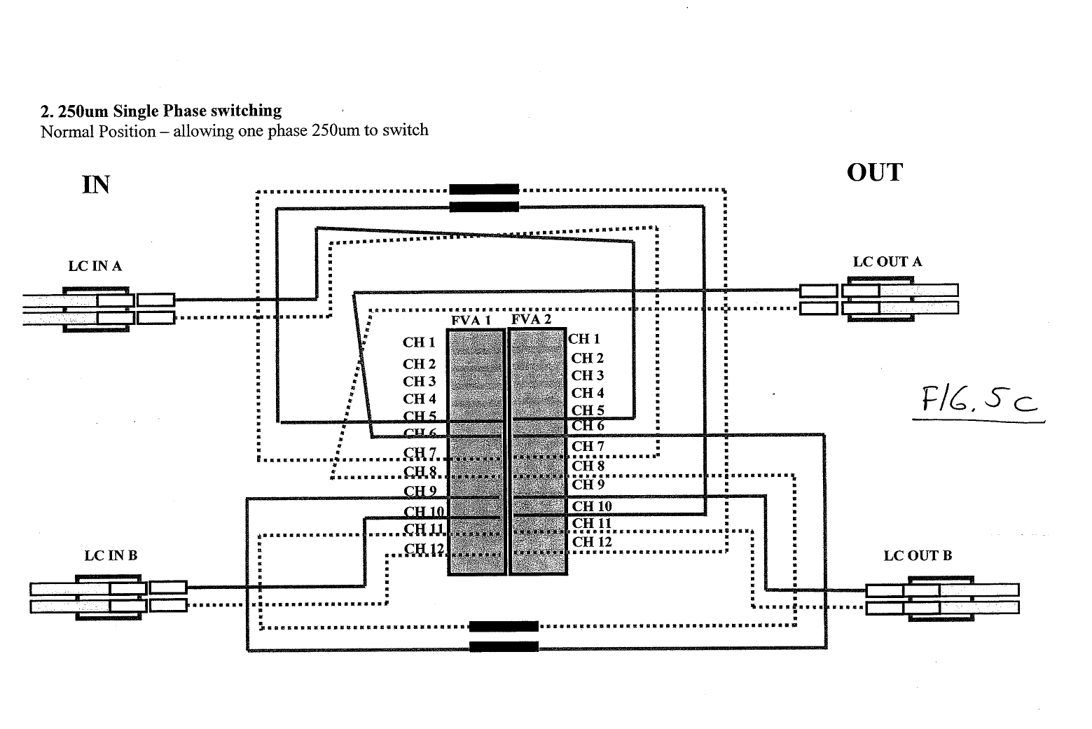

FIG. 4a is a schematic diagram of an optical normal through 70 configured in accordance with the present invention. Optical ports 72,74 on the input side are shown by arrow 79 as being optically connected together. Arrow 80 illustrates optical ports 76,78 on the back as being optically connected together. FVA 71 and FVA 75 are shown in direct slidable contact with each other at juncture 73 in the unswitched or normal or first state position.

FIG. 4 b is a schematic diagram of the optical normal through 70 in the switched or second state or position 2. Arrow 81 indicates that optical ports 72 and 76 are optically connected in the switched position. Arrow 82 indicates that optical ports 74 and 78 are optically connected in the second state or switched position. Furthermore, the MT ferrule arrays or FVAs 71 and 75 are in the switched or second state position.

FIGS. 5a illustrates a schematic diagram of an optical normal through 90 configured in accordance with the present invention in the normal or first state position for a 500 um optical connection using double phase switching. FVA1 and FVA2 are positioned so that all the channels are aligned in the first state. In the first state, optical ports LC IN A and LC IN B are optically connected, and optical ports LC OUT A and LC OUT B are optically connected.

FIG. 5b illustrates the schematic diagram 90 in the second state position wherein the FVA1 and FVA2 have moved by two channels or two phases. In the second state optical ports LC IN A and LC OUT A are optically connected, and optical ports LC IN B and LC OUT B are optically connected.

FIGS. 5c illustrates a schematic diagram of an optical normal through 92 configured in accordance with the present invention in the normal or first state position for a 250 um optical connection using single phase switching. FVA1 and FVA2 are positioned so that all the channels are aligned in the first state. In the first state, optical ports LC IN A and LC IN B are optically connected, and optical ports LC OUT A and LC OUT B are optically connected.

FIG. 5d illustrates the schematic diagram 92 in the second state position wherein the FVA1 and FVA2 have moved by one channel or one phase. In the second state optical ports LC IN A and LC OUT A are optically connected, and optical ports LC IN B and LC OUT B are optically connected.

FIGS. 5e illustrates a schematic diagram of an optical normal through 94 configured in accordance with the present invention in the normal or first state position for a 250 um optical connection using an alternative single phase switch. FVA1 and FVA2 are positioned so that all the channels are aligned in the first state. In the first state, optical ports LC IN A and LC IN B are optically connected, and optical ports LC OUT A and LC OUT B are optically connected.

FIG. 5f illustrates the schematic diagram 92 in the second state position wherein the FVA1 and FVA2 have moved by one channel or one phase. In the second state optical ports LC IN A and LC OUT A are optically connected, and optical ports LC IN B and LC OUT B are optically connected.

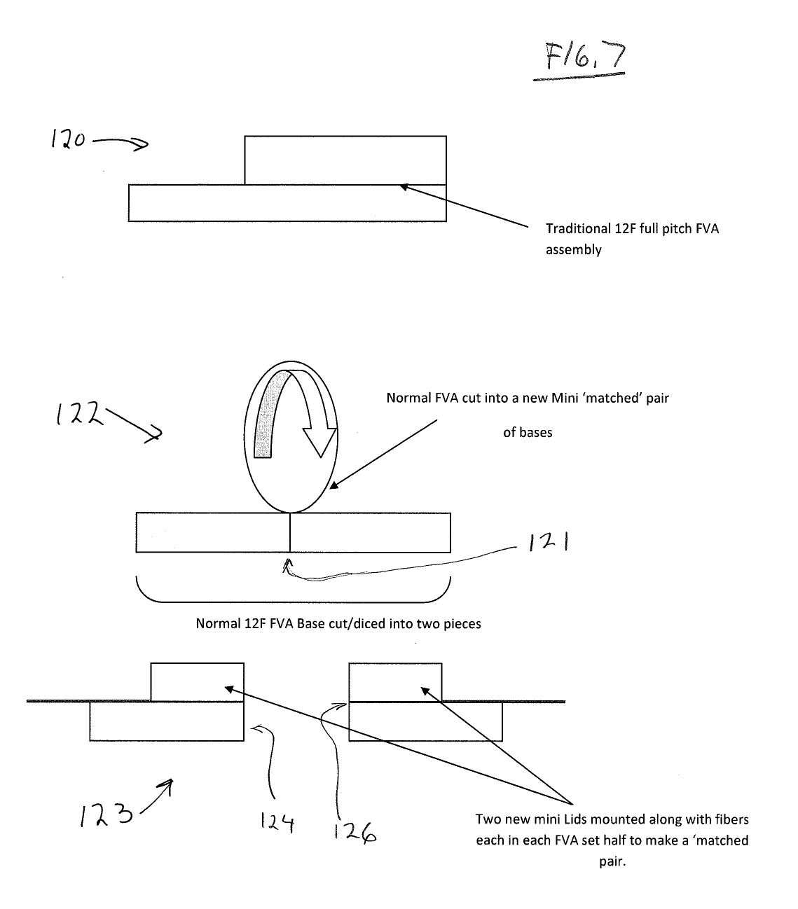

FIG. 6 illustrates an enlarged view of an MT ferrule array 102 and an MT ferrule array 104 configured in accordance with the present invention. An array of optical fibers 106 within MT ferrule array 102 and an array of optical fibers 108 in MT ferrule array 104 are precisely aligned within the same dimensional plane at a juncture 110. Apertures 112 passing through both MT ferrule arrays 102,104 can be used to initially align the arrays of optical fibers 106,108. Switching states or positions is achieved by sliding the optical fiber arrays 106,108 in the MT ferrule arrays 102,104 laterally at the juncture 110 while keeping the arrays 106,108 within the same dimensional plane. An index matching get can be applied at the juncture 110 to facilitate optical connectivity at the junction 110 and lubrication.

FIG. 7 illustrates a method for precisely manufacturing two FVA arrays aligned in the same dimensional plane. A single block or package array 120 of optical fibers is provided as shown in step 120. The package array can be constructed out of silica or Pyrex®, or other known technique for manufacturing FVAs. The single block array is then precisely cut in the mid-section to form a juncture 121 as shown by step 122. Two FVAs 124 and 126 are then produced having a “match pair” of optic fiber arrays precisely in the same dimensional plane.

While specific embodiments have been shown and described to point out fundamental and novel features of the invention as applied to the preferred embodiments, it will be understood that various omissions and substitutions and changes of the form and details of the apparatus illustrated and in the operation may be done by those skilled in the art, without departing from the spirit of the invention.

1. An optical switching apparatus, comprising:
a housing;
first and second optical ports on the housing for receiving optical connectors, said first and second optical ports being optically connected in a first state;
third and fourth optical ports for receiving optical connectors, said third and fourth optical ports being optically connected in a first state; and
an optical switch within the housing that optically connects the first optical port to the third optical port and optically connects that the second optical port to the fourth optical port in a second state, said optical switch being mechanically actuated due to insertion of an optical connector in at least one of the first and second optical ports

2. The optical switching apparatus of claim 1, wherein the optical switch includes a slidable cam that slides in response to insertion of an optical connector being inserted into at least on of the first and second ports to redirect optical connections of the optical ports.

3. The optical switching apparatus of claim 1, wherein the cam slides against a ball bearing to accurately redirect optical connections between the ports when switching to the second state.

4. The optical switching apparatus of claim 1, wherein the optical switch includes springs to keep the cam and ball bearing firmly connected while switching between the first and second states.

5. The optical switching apparatus of claim 1, wherein the first and second optical ports are designed for receiving an LC optical connector configuration.

6. The optical switching apparatus of claim 1, wherein the third and fourth optical ports are designed for receiving an LC optical connector configuration.

7. The optical switching apparatus of claim 1, wherein the optical switch includes two arrays of optical fibers located within the same geometric plane, opposing each other and in slidable contact, wherein the optical switch switches from the first state to the second state by sliding the opposing arrays of optical fibers laterally within the geometric plane in order to optically connect the first port to the third port and the second port to the fourth port.

8. The optical switching apparatus of claim 7, further comprising index matching gel between the slidable connection between the two arrays of optical fibers.

9. The optical switching apparatus of claim 7, wherein fiber the two arrays of optical fibers are formed using a Fiber V-groove Array (FVA).

10. The optical switching apparatus of claim 7, wherein the two arrays of optical fibers are formed using industry standard MT style ferrules.

11. The optical switching apparatus of claim 9, wherein increased precise mechanical matching between the two arrays of optical fibers is achieved by slicing a single FVA array to form the two arrays of optical fibers.

12. The optical switching apparatus of claim 3, wherein the cam is formed from a plate of metal including a cut-out that rides against the ball bearing to accurately switch optical connections between the first and second states.

13. The optical switching apparatus of claim 3, wherein the cam is formed from a metal rod including a cut-out that rides against the ball bearing to accurately switch optical connections between the first and second states.

14. The optical switching apparatus of claim 1, wherein the cam slides against a bearing surface bearing to accurately redirect optical connections between the ports when switching to the second state.

15. The optical switching apparatus of claim 10, wherein increased precise mechanical matching between the two arrays of optical fibers is achieved by slicing a single MT ferrule array to form a pair of matched arrays of optical fibers.
